(19) United States
(12) Patent Application Publication
(10) Pub. No.: US 2026/0361754 A1
(43) Pub. Date: Nov. 12, 2026

(54) METHOD AND APPARATUS FOR PREDICTING INFORMATION SECURITY THREAT RISK PATH OF OIL AND GAS PRODUCTION SYSTEM

(71) Applicant: CHINA UNIVERSITY OF PETROLEUM—BEIJING, Beijing (CN)

(72) Inventors: Jinqiu HU, Beijing (CN); Laibin ZHANG, Beijing (CN); Shangrui XIAO, Beijing (CN); Xinyi LI, Beijing (CN)

(73) Assignee: CHINA UNIVERSITY OF PETROLEUM—BEIJING, Beijing (CN)

(21) Appl. No.: 19/667,691

(22) Filed: May 5, 2026

(30) Foreign Application Priority Data
May 7, 2025 (CN) 202510586049.8

(51) Int. Cl. H04L 9/40; H04L 67/12

(52) U.S. Cl. CPC H04L 63/1433; H04L 67/12

(57) ABSTRACT

The present application provides a method and apparatus for predicting an information security threat risk path of an oil and gas production system. In the method, a directed network of the oil and gas production system is constructed; the propagation durations and recovery durations of nodes in the directed network are obtained by extracting the local clustering coefficients of the nodes, further, based on the propagation durations and recovery durations of the nodes, the dynamic failure propagation process of the oil and gas production system caused by information threats is simulated, and indicators of destructive power, damage scope, and recovery capability are then proposed. This approach not only facilitates the quantitative evaluation and ranking of the risk levels of different risk paths, but also facilitates the formulation of targeted security protection strategies for multiple risk paths, so as to timely block the propagation and escalation of the information threats.

### CROSS-REFERENCE TO RELATED DISCLOSURE

This application claims priority to Chinese Patent Application No. 202510586049.8, filed on May 7, 2025, which is hereby incorporated by reference in its entirety.

### TECHNICAL FIELD

The application relates to the field of industry, and in particular, to a method and apparatus for predicting an information security threat risk path of an oil and gas production system.

### BACKGROUND

In the industrial field, the supply security of oil and gas resources is usually realized through the oil and gas production-cyber physical system (OGP-CPS).

In the related art, the OGP-CPS, by collecting, transmitting and analyzing real-time data from devices in the oil and gas production system in an information layer of the OGP-CPS, realizes the construction of an information space twin corresponding to the devices in the virtual information space, through the information space twin, the behavior and status of the devices can be reflected.

However, OGP-CPS connects a plurality of devices in the information layer, making each previously relatively independent device interconnected with one another. As a result, an attack on one device in the oil and gas production system can be used to launch attacks on other directly or indirectly connected devices. There are too many attack methods for the oil and gas production system, leading to overly complex risk paths, and it is necessary to invest more security protection resources for the security protection of the oil and gas production system.

### SUMMARY

The embodiments of the present application provide a method and apparatus for predicting an information security threat risk path of an oil and gas production system, which are used to determine a perturbation risk level of various risk paths of the oil and gas production system, thereby realizing targeted security protection for the oil and gas production system and reducing resource waste.

In a first aspect, an embodiment of the present application provides a method for predicting an information security threat risk path of an oil and gas production system, including:
obtaining local clustering coefficients of a plurality of nodes, where the plurality of nodes are nodes in a target directed network constructed based on the oil and gas production system, and the plurality of nodes correspond to the plurality of devices;
determining recovery durations of the plurality of nodes and a propagation duration between each two nodes according to the local clustering coefficients of the plurality of nodes; where a recovery duration is a duration required for a node to recover from functional failure to functional validity, and the propagation duration is a duration required for function failure of a node to cause function failure of another node;
when perturbing at least one first node of the plurality of nodes, determining a failure propagation process according to the target directed network, the recovery durations of the plurality of nodes, the propagation duration between each two nodes and an initial time instant of perturbation, where the failure propagation process includes functional states of the plurality of nodes at the initial time instant, functional states of the plurality of nodes at an end time instant, and functional states of the plurality of nodes at a plurality of candidate time instants between the initial time instant and the end time instant; the end time instant is a time instant when the target directed network returns to normal; and
determining, according to the failure propagation process, a perturbation risk level of a risk path corresponding to the perturbing of the at least one first node, where the perturbation risk level is used to characterize a degree of harm to the oil and gas production system caused by an attack on at least one device corresponding to the at least one first node.

In a possible implementation, the determining, according to the failure propagation process, the perturbation risk level of the risk path corresponding to the perturbing of the at least one first node includes:
determining a plurality of target time instants from the initial time instant, the end time instant and the plurality of candidate time instants;
determining instantaneous functional states of the plurality of target time instants according to functional states of the plurality of nodes at the plurality of target time instants and device types corresponding to the plurality of nodes;
determining the perturbation risk level according to the instantaneous functional states of the plurality of target time instants.

In a possible implementation, an instantaneous functional state at a target time instant satisfies the following Formula 1:

$$r ( {t}_{k} ) = \frac{{\sum }_{n = 1}^{N} ( {α}_{n} \cdot {\sum }_{m = 1}^{{M}_{n}} ( {S}_{n m} ( {t}_{k} ) ) )}{N} ; \qquad Formula 1$$

tₖ represents the target time instant, r(tₖ) represents the instantaneous functional state corresponding to the target time instant, N represents a total number of the device types corresponding to the plurality of nodes, αₙ represents a weight corresponding to type n, Mₙ represents a total number of nodes corresponding to type n in the plurality of nodes, Sₙₘ(tₖ) represents a functional state of node m in the nodes corresponding to type n at the target time instant.

In a possible implementation, the determining the perturbation risk level according to the instantaneous functional states of the plurality of target time instants includes:
performing curve fitting processing on the instantaneous functional states of the plurality of target time instants to obtain a security resilience variation curve;
determining a damage degree parameter, a damage range parameter, and a capacity recovery parameter of the target directed network according to the security resilience variation curve; and
determining the perturbation risk level according to the damage degree parameter, the damage range parameter and the capacity recovery parameter.

In a possible implementation, the damage degree parameter S₁ satisfies the following Formula 2:

$${S}_{1} = A - {\int }_{{t}_{start}}^{{t}_{end}} R ( t ) dt ; \qquad Formula 2$$

A represents a preset value associated with the end time instant and the initial time instant, t_{end} represents the end time instant, tₛₜₐᵣₜ represents the initial time instant, R(t) represents the security resilience variation curve, ∫ represents an integral sign, and dt represents a differential sign;
the damage range parameter S₂ satisfies the following Formula 3:

S₂=1/Rₘᵢₙ Formula 3;
Rₘᵢₙ represents a minimum value of R(t), and/represents a division operation;
the capacity recovery parameter S₃ satisfies the following Formula 4:

$$\{ \begin{matrix}{S}_{3} = \frac{1}{P} {\sum }_{p = 1}^{P} \vert {K}_{p} \vert \\ {S}_{3} = 0\end{matrix} ; \qquad Formula 4$$

P represents a number of at least one sub-curve, the at least one sub-curve is a curve obtained by dividing a first curve according to at least two first time instants, the at least two first time instants include a target time instant corresponding to Rₘᵢₙ, t_{end}, and a target time instant between the target time instant corresponding to Rₘᵢₙ and t_{end}, the first curve is a curve between the target time instant corresponding to Rₘᵢₙ and the end time instant in R(t), Kₚ represents a slope corresponding to curve p in the at least one sub-curve.

In a possible implementation, the determining the perturbation risk level according to the damage degree parameter, the damage range parameter, and the capacity recovery parameter includes:
determining a product of the damage degree parameter and the damage range parameter; and
determining a ratio of the product to the capacity recovery parameter as the perturbation risk level.

In a possible implementation, obtaining a local clustering coefficient of a node in the target directed network includes:
determining the local clustering coefficient of the node according to a number of at least one adjacent node of the node and a number of an edge between the at least one adjacent node; and
a local clustering coefficient C(i) of a node i in the plurality of nodes satisfies the following Formula 5:

$$C ( i ) = \frac{{e}_{i}}{{k}_{i} ( {k}_{i} - 1 )} ; \qquad Formula 5$$

kᵢ represents a number of adjacent nodes of the node i, and eᵢ represents a number of an edge between the adjacent nodes.

In a possible implementation, a recovery duration Tᵣ(i) of a node i in the plurality of nodes satisfies the following Formula 6:

Tᵣ(i)=C(i)·T_{rbase} Formula 6;
C(i) represents a local clustering coefficient of the node i, and T_{rbase} represents a basic recovery duration;
a propagation duration Tₚ(i,j) between the node i and a node j in the plurality of nodes satisfies the following Formula 7:

$${T}_{p} ( i , j ) = ( 1 - \frac{C ( i ) + C ( j )}{2} ) \cdot {T}_{pbase} ; \qquad Formula 7$$

C(j) represents a local clustering coefficient of the node j, and T_{pbase} represents a basic propagation duration.

In a possible implementation, the method further includes:
constructing an initial directed network of the oil and gas production system according to device information of the plurality of devices in the oil and gas production system and a connection relationship between the plurality of devices, where the initial directed network includes the plurality of nodes and an edge between the plurality of nodes, and the edge indicates that there is a connection between devices corresponding to nodes on the edge, and a direction of the edge indicates an information transmission direction or an oil and gas transmission direction between the devices corresponding to the nodes on the edge;
determining an average path length and an average clustering coefficient of the initial directed network;
determining an optimal reconnection probability of the initial directed network according to the average path length and the average clustering coefficient; and
adjusting the edge between the plurality of nodes in the initial directed network according to the optimal reconnection probability to obtain the target directed network.

In a second aspect, an embodiment of the present application provides an apparatus for predicting an information security threat risk path of an oil and gas production system, including:
an obtaining module, configured to obtain local clustering coefficients of a plurality of nodes, where the plurality of nodes are nodes in a target directed network constructed based on the oil and gas production system, and the plurality of nodes correspond to the plurality of devices; and
a determining module, configured to determine recovery durations of the plurality of nodes and a propagation duration between each two nodes according to the local clustering coefficients of the plurality of nodes; where a recovery duration is a duration required for a node to recover from functional failure to functional validity, the propagation duration is a duration required for function failure of a node to cause function failure of another node;
the determining module is further configured to: when perturbing at least one node of the plurality of nodes, determine a failure propagation process according to the target directed network, the recovery durations of the plurality of nodes, the propagation duration between each two nodes and an initial time instant of perturbation, where the failure propagation process includes functional states of the plurality of nodes at the initial time instant, functional states of the plurality of nodes at an end time instant, and functional states of the plurality of nodes at a plurality of candidate time instants between the initial time instant and the end time instant; the end time instant is a time instant when the target directed network returns to normal; and
the determining module is further configured to determine, according to the failure propagation process, a perturbation risk level of a risk path corresponding to the perturbing of the at least one node, where the perturbation risk level is used to characterize a degree of harm to the oil and gas production system caused by an attack on at least one device corresponding to the at least one node.

In a possible implementation, the determining module is specifically configured to:
determine a plurality of target time instants from the initial time instant, the end time instant and the plurality of candidate time instants;
determine instantaneous functional states of the plurality of target time instants according to functional states of the plurality of nodes at the plurality of target time instants and device types corresponding to the plurality of nodes; and
determine the perturbation risk level according to the instantaneous functional states of the plurality of target time instants.

In a possible implementation, an instantaneous functional state at the target time instant satisfies the following Formula 1:

$$r ( {t}_{k} ) = \frac{{\sum }_{n = 1}^{N} ( {α}_{n} \cdot {\sum }_{m = 1}^{{M}_{n}} ( {S}_{n m} ( {t}_{k} ) ) )}{N} ; \qquad Formula 1$$

tₖ represents the target time instant, r(tₖ) represents the instantaneous functional state corresponding to the target time instant, N represents a total number of the device types corresponding to the plurality of nodes, αₙ represents a weight corresponding to type n, Mₙ represents a total number of nodes corresponding to type n in the plurality of nodes, Sₙₘ(tₖ) represents a functional state of node m in the node corresponding to type n at the target time instant.

In a possible implementation, the determining module is specifically configured to:
perform curve fitting processing on the instantaneous functional states of the plurality of target time instants to obtain a security resilience variation curve;
determine a damage degree parameter, a damage range parameter, and a capacity recovery parameter of the target directed network according to the security resilience variation curve; and
determine the perturbation risk level according to the damage degree parameter, the damage range parameter and the capacity recovery parameter.

In a possible implementation, the damage degree parameter S₁ satisfies the following Formula 2:

$${S}_{1} = A - {\int }_{{t}_{start}}^{{t}_{end}} R ( t ) dt ; \qquad Formula 2$$

A represents a preset value associated with the end time instant and the initial time instant, t_{end} represents the end time instant, tₛₜₐᵣₜ represents the initial time instant, R(t) represents the security resilience variation curve, ∫ represents an integral sign, and dt represents a differential sign;
the damage range parameter S₂ satisfies the following Formula 3:

S₂=1/Rₘᵢₙ Formula 3;
Rₘᵢₙ represents a minimum value of R(t), and/represents a division operation;
the capacity recovery parameter S₃ satisfies the following Formula 4:

$$\{ \begin{matrix}{S}_{3} = \frac{1}{P} {\sum }_{p = 1}^{P} \vert {K}_{p} \vert \\ {S}_{3} = 0\end{matrix} ; \qquad Formula 4$$

P represents a number of at least one sub-curve, the at least one sub-curve is a curve obtained by dividing a first curve according to at least two first time instants, the at least two first time instants include a target time instant corresponding to Rₘᵢₙ, t_{end}, and a target time instant between the target time instant corresponding to Rₘᵢₙ and t_{end}, the first curve is a curve between the target time instant corresponding to Rₘᵢₙ and the end time instant in R(t), Kₚ represents a slope corresponding to curve p in the at least one sub-curve.

In a possible implementation, the determining module is specifically configured to:
determine a product of the damage degree parameter and the damage range parameter; and
determine a ratio of the product to the capacity recovery parameter as the perturbation risk level.

In a possible implementation, the obtaining module is specifically configured to:
determine the local clustering coefficient of the node according to a number of at least one adjacent node of the node and a number of an edge between the at least one adjacent node; and
a local clustering coefficient C(i) of a node i in the plurality of nodes satisfies the following Formula 5:

$$C ( i ) = \frac{{e}_{i}}{{k}_{i} ( {k}_{i} - 1 )} ; \qquad Formula 5$$

kᵢ represents a number of adjacent nodes of the node i, and eᵢ represents a number of an edge between the adjacent nodes.

In a possible implementation, a recovery duration Tᵣ(i) of a node i in the plurality of nodes satisfies the following Formula 6:

Tᵣ(i)=C(i)·T_{rbase} Formula 6;
C(i) represents a local clustering coefficient of the node i, and T_{rbase} represents a basic recovery duration;
a propagation duration Tₚ(i,j) between the node i and a node j in the plurality of nodes satisfies the following Formula 7:

$${T}_{p} ( i , j ) = ( 1 - \frac{C ( i ) + C ( j )}{2} ) \cdot {T}_{pbase} ; \qquad Formula 7$$

C(j) represents a local clustering coefficient of the node j, and T_{pbase} represents a basic propagation duration.

In a possible embodiment, the determining module is further configured to:
construct an initial directed network of the oil and gas production system according to device information of the plurality of devices in the oil and gas production system and a connection relationship between the plurality of devices, where the initial directed network includes the plurality of nodes and an edge between the plurality of nodes, and the edge indicates that there is a connection between devices corresponding to nodes on the edge, and a direction of the edge indicates an information transmission direction or an oil and gas transmission direction between the devices corresponding to the nodes on the edge;
determine an average path length and an average clustering coefficient of the initial directed network;
determine an optimal reconnection probability of the initial directed network according to the average path length and the average clustering coefficient; and
adjust the edge between the plurality of nodes in the initial directed network according to the optimal reconnection probability to obtain the target directed network.

In a third aspect, an embodiment of the present application provides an electronic device, including a memory and a processor;
the memory stores computer-executable instructions;
the processor executes the computer-executable instructions stored in the memory, such that the processor implements the method described in the first aspect and/or any possible implementation manner of the first aspect;

In a fourth aspect, the present application provides a computer-readable storage medium, the computer-readable storage medium stores computer-executable instructions, when executed by a processor, the computer-executable instructions implement the various possible embodiments described in the first aspect and/or the first aspect above.

In a fifth aspect, the present application provides a computer program product, the computer program product includes a computer program, when executed by a processor, the computer program implements the various possible embodiments described in the first aspect and/or the first aspect above.

The method and apparatus for predicting an information security threat risk path of the oil and gas production system provided in the embodiments of the present application, determine recovery durations of the plurality of nodes and a propagation duration between each two nodes according to the local clustering coefficients of the plurality of nodes, when perturbing at least one first node of the plurality of nodes, determine a failure propagation process according to the target directed network, the recovery durations of the plurality of nodes, the propagation duration between each two nodes and an initial time instant of perturbation, determine, according to the failure propagation process, a perturbation risk level of a risk path corresponding to the perturbing of the at least one first node, it is thus possible to formulate targeted security protection strategies for various risk paths according to the perturbation risk levels of the various risk paths, so as to timely block the propagation and escalation of information threats and reduce the waste of security protection resources.

### BRIEF DESCRIPTION OF DRAWINGS

The drawings herein are incorporated into the description and constitute a part of this description, illustrate embodiments consistent with the present application, and are used to explain the principles of the present application together with the description.

FIG. 1 is a first schematic flow chart of a method for predicting an information security threat risk path of an oil and gas production system provided by an embodiment of the present application.

FIG. 2 is a schematic diagram of a failure propagation process at a certain time instant provided by an embodiment of the present application.

FIG. 3 is a second schematic flowchart of a method for predicting an information security threat risk path of an oil and gas production system provided by an embodiment of the present application.

FIG. 4 is a third schematic flowchart of a method for predicting an information security threat risk path of an oil and gas production system provided by an embodiment of the present application.

FIG. 5 is a schematic diagram of a security resilience variation curve provided by an embodiment of the present application.

FIG. 6 is a fourth schematic flowchart of a method for predicting an information security threat risk path of an oil and gas production system provided by an embodiment of the present application.

FIG. 7 is a schematic flowchart of a method for determining an optimal reconnection probability provided by an embodiment of the present application.

FIG. 8 is a schematic structural diagram of an apparatus for predicting an information security threat risk path of an oil and gas production system provided by an embodiment of the present application.

FIG. 9 is a structural diagram of an electronic device provided by an embodiment of the present application.

Through the above drawings, explicit embodiments of the present application have been shown, and more detailed descriptions will be provided in the following text. These drawings and textual descriptions are not intended to limit the scope of the concept of the present application in any way, but rather to explain the concept of the present application to those skilled in the art by referring to specific embodiments.

### DESCRIPTION OF EMBODIMENTS

Exemplary embodiments will be described here in detail, with examples shown in the drawings. When the following description refers to the drawings, unless otherwise indicated, the same numbers in different drawings indicate the same or similar elements. The embodiments described in the following exemplary embodiments do not represent all embodiments consistent with the present application. Rather, they are merely examples of apparatuses and methods consistent with some aspects of the present application as detailed in the appended claims.

In the embodiments of the present application, terms such as “first” and “second” are used to distinguish the same items or similar items with substantially the same functions and effects. For example, the first value and the second value are merely to distinguish different values and do not limit their order of sequence. Those skilled in the art can understand that terms such as “first” and “second” do not limit the quantity or execution order, and such terms do not necessarily limit the items to be different.

It should be noted that in the embodiments of the present application, words such as “exemplarily” or “for example” are used to represent examples, illustrations, or explanations. Any embodiment or design solution described as “exemplarily” or “for example” in the present application should not be construed as being more preferred or advantageous than other embodiments or design solutions. Rather, the use of words such as “exemplarily” or “for example” is intended to present relevant concepts in a specific manner.

In the embodiments of the present application, “at least one” refers to one or more, and “a plurality of” refers to two or more. “And/or” describes the association relationship between associated objects, indicating that three relationships may exist. For example, A and/or B may indicate: the case where A exists alone, the case where A and B exist simultaneously, or the case where B exists alone, where A and B may be singular or plural. The character “/” generally indicates that the associated objects before and after it have an “or” relationship. “At least one of the following” or similar expressions refer to any combination of these items, including any combination of a single item (or individual) or a plurality of items (or individuals). For example, at least one of a, b, or c may represent: a, b, c, a-b, a-c, b-c, or a-b-c, where a, b, and c may be single or multiple.

In the industrial field, ensuring the supply security of oil and gas resources is still an important strategic issue for the development of all countries. In related art, the supply security of oil and gas resources is usually realized through the oil and gas production-cyber physical system (OGP-CPS).

The OGP-CPS, by collecting, transmitting and analyzing real-time data from physical entities of devices in the oil and gas production system in an information layer of the OGP-CPS, realizes the construction of an information space twin corresponding to the devices in the virtual information space, through the information space twin, the behavior and status of the devices can be reflected.

However, OGP-CPS connects a plurality of devices in the information layer, making each previously relatively independent device interconnected with one another. As a result, an attack on one device in the oil and gas production system can be used to launch attacks on other directly or indirectly connected devices. There are too many attack methods for the oil and gas production system, leading to overly complex risk paths, and it is necessary to invest more security protection resources for the security protection of the oil and gas production system.

In view of this, the present application proposes a method for predicting an information security threat risk path of an oil and gas production system. The method determines a failed node by perturbing a first node, determines the recovery durations of a plurality of failed nodes by determining local clustering coefficients, and further determines, according to the recovery durations of the plurality of failed nodes and the propagation duration between the plurality of failed nodes, a perturbation risk level corresponding to the first node. By perturbing the first node to determine the failed node, a risk path corresponding to the first node can be predicted. Consequently, targeted security protection strategies for multiple risk paths can be formulated according to the perturbation risk levels corresponding to the plurality of first nodes, thereby reducing the waste of security protection resources.

Specific embodiments are provided below to elaborate on the technical solutions of the present application and how these technical solutions address the aforementioned technical problems. Furthermore, these specific embodiments may be combined with each other, and the same or similar concepts or processes may not be repeated in certain embodiments. Finally, the embodiments of the present application will be described with reference to the drawings.

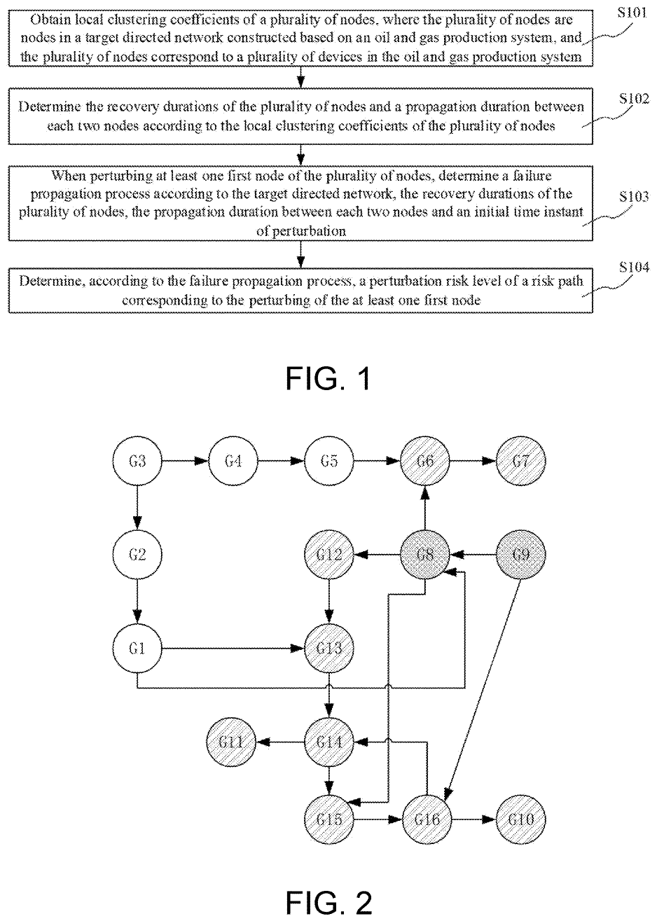

FIG. 1 is a first schematic flow chart of a method for predicting an information security threat risk path of an oil and gas production system provided by an embodiment of the present application, as shown in FIG. 1, the method includes:
S101, obtain local clustering coefficients of a plurality of nodes, where the plurality of nodes are nodes in a target directed network constructed based on an oil and gas production system, and the plurality of nodes correspond to a plurality of devices in the oil and gas production system.

In an implementation, the execution subject of the embodiment of the present application is an electronic device, or an apparatus for predicting an information security threat risk path of an oil and gas production system disposed in the electronic device, and the apparatus for predicting an information security threat risk path of an oil and gas production system may be implemented through a combination of software and/or hardware.

The target directed network includes an edge between the plurality of nodes, the plurality of nodes correspond to the plurality of devices, the edge indicate that there is connection between devices corresponding to nodes on the edge, and a direction of the edge indicates an information transmission direction or oil and gas transmission direction between the devices corresponding to the nodes on the edge.

In an implementation, the plurality of devices include but are not limited to, pipelines, pumps, valves, sensors, controllers, or actuators, etc.

For example, when the devices corresponding to the nodes on an edge are a pipeline and a pump, the edge indicates that there is a connection between the pipeline and the pump, and the direction of the edge indicates the oil and gas transmission direction between the pipeline and the pump. If the oil and gas transmission direction is that oil and gas flows from the pipeline into the pump, the direction of the edge between the pipeline and the pump is from the node corresponding to the pipeline to the node corresponding to the pump.

For example, when the devices corresponding to the nodes on an edge are a sensor and a controller, the edge indicates that there is a connection between the sensor and the controller, and the direction of the edge indicates the information transmission direction between the sensor and the controller. If the sensor is responsible for monitoring oil and gas pressure in the pipeline in real time, after the sensor detects pressure data of the oil and gas pressure, transmits the pressure data to the controller, at this time, the direction of the edge between the sensor and the controller is from a node corresponding to the sensor to a node corresponding to the controller.

The local clustering coefficient of a node indicates a degree of connection tightness between the node and other nodes, and it can also be understood that the local clustering coefficient indicates a degree of connection tightness between a device corresponding to the node and other devices.

In a possible embodiment, constructing, according to device information of a plurality of devices in the oil and gas production system and a connection relationship between the plurality of devices, a target directed network of the oil and gas production system includes:
determining the device information of the plurality of devices of the oil and gas production system, and determining a plurality of physical devices and a plurality of information devices;
determining a plurality of nodes according to the plurality of physical devices and the plurality of information devices of the oil and gas production system, where the plurality of nodes include a plurality of physical nodes and a plurality of information nodes;
determining a connection relationship between the plurality of devices;
determining a plurality of edges according to the connection relationship between the plurality of devices;
constructing a basic network according to the plurality of physical nodes;
constructing an information-physical control feedback substructure according to the plurality of information nodes and the plurality of edges;
embedding the information-physical control feedback substructure in the basic network to construct the target directed network of the oil and gas production system.

S102, determine recovery durations of the plurality of nodes and a propagation duration between each two nodes according to the local clustering coefficients of the plurality of nodes.

In a possible embodiment, the embodiment of the present application defines, based on the influence propagation and recovery model (IRML) method, three time parameters, namely a perturbation duration, a propagation duration and a recovery duration, which are used to characterize a dynamic behavior of functional failure of the oil and gas production system after the oil and gas production system is attacked.

The perturbation duration is a duration for which a node is perturbed, or a duration for which perturbation is applied to the node, and can also be defined as an interference duration for which an emergency acts on the node. The perturbation duration is related to the emergency itself and is a user-defined parameter.

The propagation duration between each two nodes is a duration required for function failure of a node to cause function failure of another node, or after functional failure of a node, the time interval from the functional failure of the node to the propagation to another node leading to functional failure of another node.

The recovery duration of the node is a duration required for the node to recover from functional failure to functional validity, or after functional failure of a node, the time interval from the start of recovery to the complete recovery of function, which is used to characterize the difficulty of functional recovery of the node.

The recovery duration of the node can be understood as a recovery duration of a device corresponding to the node.

The propagation duration between each two nodes can be understood as a propagation duration between two devices corresponding to two nodes.

The perturbation duration of the node can be understood as a perturbation duration of a device corresponding to the node.

A duration for which the node is perturbed can be understood as the continuous duration that the node is attacked.

The function failure of the node can be understood as abnormal operation of a device corresponding to the node.

The function validity of the node can be understood as normal operation of a device corresponding to the node.

S103, when perturbing at least one first node of the plurality of nodes, determine a failure propagation process according to the target directed network, the recovery durations of the plurality of nodes, the propagation duration between each two nodes and an initial time instant of perturbation.

The failure propagation process includes functional states of the plurality of nodes at the initial time instant, the functional states at an end time instant, and the functional states of a plurality of candidate time instants between the initial time instant and the end time instant, and the end time instant is a time instant when the target directed network returns to normal.

In an implementation, the end time instant is determined by summing recovery durations of a plurality of failed nodes, a propagation duration between the plurality of failed nodes, and an initial time instant of perturbing the first node.

The target directed network returning to normal can be understood as the oil and gas production system corresponding to the target directed network being functionally valid, or each node in the target directed network being functionally valid.

In a possible implementation, the determining the failure propagation process according to the target directed network, the recovery durations of the plurality of nodes, the propagation duration between each two of nodes, and the initial time instant of perturbation includes:
determining a plurality of failed nodes according to the target directed network, where a failed node is a node with functional failure or potential functional failure in the plurality of nodes when the first node is perturbed;
determining the failure propagation process according to the recovery durations of the plurality of nodes, the propagation duration between each two of nodes, and the initial time instant of perturbation.

The failed node include one or more of the following: an already-failed node, or a to-be-propagated failed node. The already-failed node is a node with functional failure in the plurality of nodes, and the to-be-propagated failed node is a node with potential functional failure in the plurality of nodes.

The already-failed node includes the first node. The first node may be referred to as an initial failed node.

The to-be-propagated failed node refers to another node in the target directed network that are directly or indirectly affected by the functional failure of the first node and thus experiences functional failure.

According to the target directed network and the plurality of failed nodes, a normal operating node can also be determined. The normal operating node is a node other than the plurality of failed nodes in the target directed network.

FIG. 2 is a schematic diagram of a failure propagation process at a certain time instant provided by an embodiment of the present application, as shown in FIG. 2, a target directed network includes a plurality of nodes, the plurality of nodes include G1, G2, G3, G4, G5, G6, G7, G8, G9, G10, G11, G12, G13, G14, G15 and G16.

A first node is G9, already-failed nodes are G8 and G9, to-be-propagated failed nodes include G6, G7, G10, G11, G12, G13, G14, G15, G16, and normal operating nodes include G1, G2, G3, G4, G5.

G9 points to G8, indicating that a direction of an edge is from G9 to G8, the node connected to the start point of the edge is G9, and the node connected to the end point of the edge is G8.

S104, determine, according to the failure propagation process, a perturbation risk level of a risk path corresponding to the perturbing of the at least one first node.

Specifically, according to functional states of the plurality of nodes at the an initial time instant, functional states at an end time instant, and functional states at a plurality of candidate time instants between the initial time instant and the end time instant, determine the perturbation risk level of the risk path corresponding to the perturbation of at least one first node.

The perturbation risk level is used to characterize a degree of harm to the oil and gas production system caused by the attack on a device corresponding to the at least one first node.

The perturbation of at least one first node corresponds to one risk path.

The higher the perturbation risk level, the greater the degree of harm to the oil and gas production system caused by the attack on the device corresponding to the at least one first node.

In the embodiment shown in FIG. 1, by determining local clustering coefficients of the plurality of nodes in the target directed network, determining the recovery durations of the plurality of nodes and the propagation duration between each two of nodes, then determining the failure propagation process resulting from perturbing at least one first node, and further determining the perturbation risk level of the risk path corresponding to the perturbing of at least one first node, it is thus possible to formulate targeted security protection strategies for various risk paths according to the perturbation risk levels of the various risk paths, thereby reducing the waste of security protection resources.

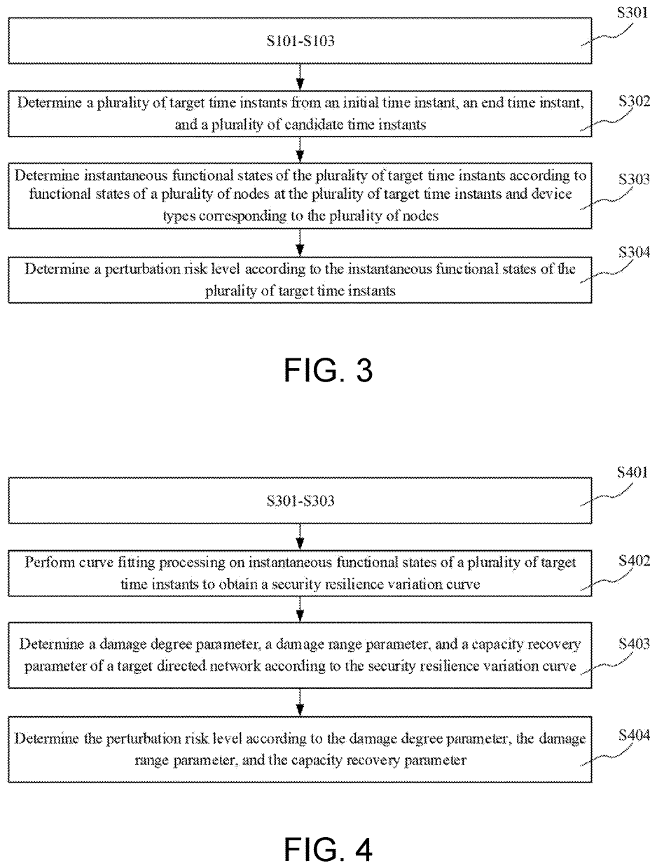

FIG. 3 is a second schematic flowchart of a method for predicting an information security threat risk path of an oil and gas production system provided by an embodiment of the present application, as shown in FIG. 3, the method includes the following steps.

S301, execute the above S101-S103.

S302, determine a plurality of target time instants from an initial time instant, an end time instant, and a plurality of candidate time instants.

The plurality of target time instants include the initial time instant, the end time instant, and at least one time instant selected from the plurality of candidate time instants.

In a possible implementation, the at least one time instant selected from the plurality of candidate time instants may be: at least one time instant randomly selected from the plurality of candidate time instants.

S303, determine instantaneous functional states of the plurality of target time instants according to functional states of a plurality of nodes at the plurality of target time instants and device types corresponding to the plurality of nodes.

The functional states of a node include functional failure and functional validity.

The functional state of a node can be represented by a numerical value. For example, functional failure is represented as 0, and functional validity is represented as 1.

In a possible implementation, the determining the instantaneous functional states of the plurality of target time instants according to the functional states of the plurality of nodes at the plurality of target time instants and the device types corresponding to the plurality of nodes includes:
determining N device types corresponding to the plurality of nodes;
determining N weights corresponding to the N device types based on experience;
determining the functional states of the plurality of nodes at the plurality of target time instants according to the failure propagation process;
determining an instantaneous functional state of the target time instant according to the functional states of the plurality of nodes at the plurality of target time instants and the N weights.

In a possible implementation, the instantaneous functional state of the target time instant satisfies the following Formula 1:

$$r ( {t}_{k} ) = \frac{{\sum }_{n = 1}^{N} ( {α}_{n} \cdot {\sum }_{m = 1}^{{M}_{n}} ( {S}_{n m} ( {t}_{k} ) ) )}{N} ; \qquad Formula 1$$

tₖ represents the target time instant, r(tₖ) represents the instantaneous functional state corresponding to the target time instant, N represents the total number of the device types corresponding to the plurality of nodes, αₙ represents a weight corresponding to type n, n=1, . . . , N, Mₙ represents a total number of nodes corresponding to type n in the plurality of nodes, Sₙₘ(tₖ) represents the functional state of node m in the node corresponding to type n at the target time instant m=1, . . . , M.

The instantaneous functional state at the target time instant can be understood as the instantaneous functional state of the oil and gas production system at the target time instant.

S304, determine a perturbation risk level according to the instantaneous functional states of the plurality of target time instants.

In the embodiment shown in FIG. 3, among the initial time instant, the end time instant, and the plurality of candidate time instants, the plurality of target time instants are determined; according to the functional states of the plurality of nodes at the plurality of target time instants and the device types corresponding to the plurality of nodes, the instantaneous functional states of the plurality of target time instants are determined; and according to the instantaneous functional states of the plurality of target time instants, the perturbation risk level is determined. Through the above method, by determining the instantaneous functional states at multiple preset time instants according to the functional states of the plurality of nodes during the failure propagation process, and then determining the perturbation risk level corresponding to the first node, the perturbation risk level can be more accurately determined.

FIG. 4 is a third schematic flowchart of a method for predicting an information security threat risk path of an oil and gas production system provided by an embodiment of the present application, as shown in FIG. 4, the method includes the following steps.

S401, S301-S303.

S402, perform curve fitting processing on instantaneous functional states of a plurality of target time instants to obtain a security resilience variation curve.

It is worth noting that the curve fitting processing refers to related art and will not be repeated here.

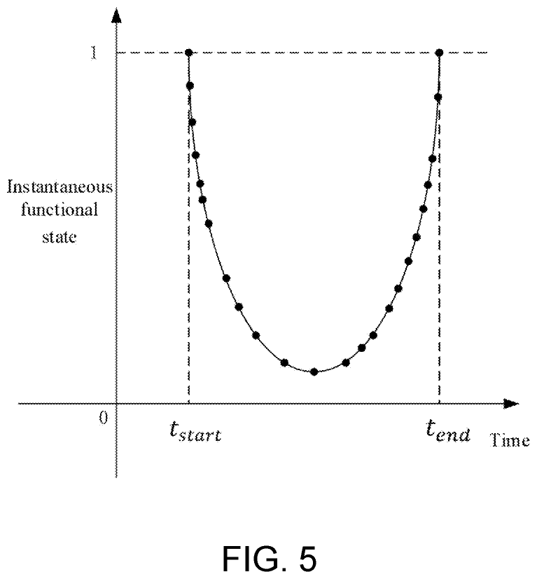

FIG. 5 is a schematic diagram of a security resilience variation curve provided by an embodiment of the present application, as shown in FIG. 5, the horizontal axis represents time, the vertical axis represents instantaneous functional state, and a solid dot represents an instantaneous functional state at a target time instant.

When the functional validity is represented as 1 and the functional failure is represented as 0, the range of the instantaneous functional state is between 0 and 1.

t_{end} represents an end time instant, and tₛₜₐᵣₜ represents an initial time instant.

S403, determine a damage degree parameter, a damage range parameter, and a capacity recovery parameter of a target directed network according to the security resilience variation curve.

In a possible implementation, the damage degree parameter S₁ satisfies the following Formula 2:

$${S}_{1} = A - {\int }_{{t}_{start}}^{{t}_{end}} R ( t ) dt ; \qquad Formula 2$$

A represents a preset value associated with the end time instant and the initial time instant, t_{end} represents the end time instant, tₛₜₐᵣₜ represents the initial time instant, R(t) represents the security resilience variation curve, ∫ represents an integral sign, and dt represents a differential sign.

For example, when the functional validity is represented as 1, the preset value associated with the end time instant and the initial time instant is the absolute value of the difference between the end time instant and the initial time instant.

In a possible implementation, the damage range parameter S₂ satisfies the following Formula 3:

S₂=1/Rₘᵢₙ Formula 3;
Rₘᵢₙ represents the minimum value of R(t), and/represents the division operation.

In a possible implementation, the capacity recovery parameter S₃ satisfies the following Formula 4:

$$\{ \begin{matrix}{S}_{3} = \frac{1}{P} {\sum }_{p = 1}^{P} \vert {K}_{p} \vert \\ {S}_{3} = 0\end{matrix} ; \qquad Formula 4$$

P represents a number of at least one sub-curve, the at least one sub-curve is a curve obtained by dividing a first curve according to at least two first time instants, the at least two first time instants include a target time instant corresponding to Rₘᵢₙ, t_{end}, and a target time instant between the target time instant corresponding to Rₘᵢₙ and t_{end}, the first curve is a curve between the target time instant corresponding to Rₘᵢₙ and the end time instant in R(t); Kₚ represents a slope corresponding to curve p in the at least one sub-curve.

The slope corresponding to curve p can be understood as the ratio of the absolute value of the difference between the instantaneous functional states corresponding to the two first time instants of curve p to the absolute value of the difference between the two first time instants.

When the difference between the target time instant corresponding to Rₘᵢₙ and the end time instant in R(t) is less than a first preset value, P equals 1, indicating that the target directed network can quickly recover to functional validity. The first preset value is, for example, 5 hours.

After perturbing at least one first node in the plurality of nodes, if the target directed network can recover to functional validity, the capacity recovery parameter satisfies

$${S}_{3} = \frac{1}{P} {\sum }_{p = 1}^{P} \vert {K}_{p} \vert ;$$

if the target directed network cannot recover to functional validity, the capacity recovery parameter satisfies S₃=0.

The target directed network being functionally valid can be understood as each node in the target directed network being functionally valid, the oil and gas production system being functionally valid, or each device in the oil and gas production system being functionally valid.

S404, determine the perturbation risk level according to the damage degree parameter, the damage range parameter, and the capacity recovery parameter.

In a possible implementation, the determining the perturbation risk level according to the damage degree parameter, the damage range parameter, and the capacity recovery parameter includes:
determining a product of the damage degree parameter and the damage range parameter; and
determining a ratio of the product to the capacity recovery parameter as the perturbation risk level.

The damage degree parameter, the damage range parameter, the capacity recovery parameter, and the perturbation risk level satisfy the following Formula 8:

$${D}_{i} = \frac{{S}_{1} \cdot {S}_{2}}{{S}_{3}} ; \qquad Formula 8$$

Dᵢ represents the perturbation risk level corresponding to the i-th first node.

In the embodiment shown in FIG. 4, curve fitting processing is performed on the instantaneous functional states of the plurality of target time instants to obtain the security resilience variation curve; the damage degree parameter, the damage range parameter, and the capacity recovery parameter of the target directed network are determined according to the security resilience variation curve; the perturbation risk level is determined according to the damage degree parameter, the damage range parameter, and the capacity recovery parameter. In the above method, by performing curve fitting processing on the instantaneous functional states of the plurality of target time instants to obtain the security resilience variation curve, and then determining the damage degree parameter, the damage range parameter, and the capacity recovery parameter of the target directed network according to the security resilience variation curve, the impact of subjective factors on the process from perturbing the first node to propagation until the oil and gas production system recovers to functional validity can be reduced, and the accuracy of determining the perturbation risk level can be improved.

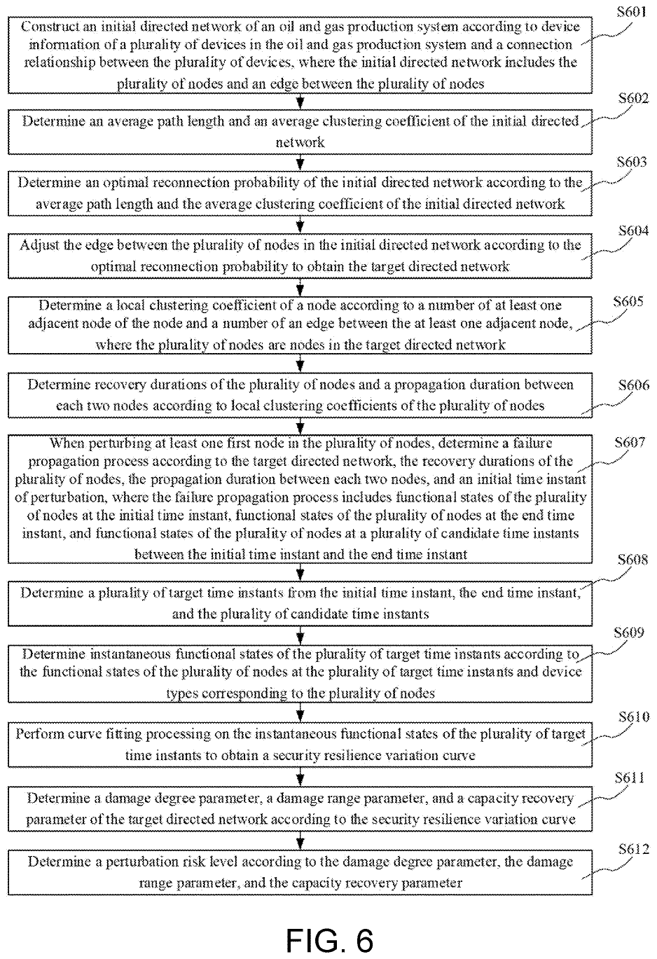

FIG. 6 is a fourth schematic flowchart of a method for predicting an information security threat risk path of an oil and gas production system provided by an embodiment of the present application, as shown in FIG. 6, the method includes the following steps.

S601, construct an initial directed network of an oil and gas production system according to device information of a plurality of devices in the oil and gas production system and a connection relationship between the plurality of devices, where the initial directed network includes the plurality of nodes and an edge between the plurality of nodes.

The edge indicates that there is a connection between devices corresponding to nodes on the edge, and a direction of the edge indicates an information transmission direction or an oil and gas transmission direction between the devices corresponding to the nodes on the edge.

In a possible implementation, the constructing the initial directed network of the oil and gas production system according to the device information of the plurality of devices in the oil and gas production system and the connection relationship between the plurality of devices includes:
determining the device information of the plurality of devices in the oil and gas production system, and determine a plurality of physical devices and a plurality of information devices;
determining a plurality of nodes according to the plurality of physical devices and the plurality of information devices of the oil and gas production system, where the plurality of nodes include a plurality of physical nodes and a plurality of information nodes;
determining the connection relationship between the plurality of devices;
determining a plurality of edges according to the connection relationship between the plurality of devices;
constructing a basic network according to the plurality of physical nodes;
constructing an information-physical control feedback substructure according to the plurality of information nodes and the plurality of edges; and
embedding the information-physical control feedback substructure in the basic network to construct the target directed network of the oil and gas production system.

S602, determine an average path length and an average clustering coefficient of the initial directed network.

In a possible implementation, the determining the average path length and the average clustering coefficient of the initial directed network includes:
determining the average path length of the initial directed network; and
determining the average clustering coefficient of the initial directed network.

In a possible implementation, determining the average path length of the initial directed network includes:
determining a shortest path length between each two nodes according to the initial directed network; and
determining the average path length according to the shortest path length between each two nodes and the total number of the plurality of nodes.

In an implementation, the average path length of the initial directed network satisfies the following Formula 9:

$${L}_{r e g u l a r} = \frac{{\sum }_{x \neq y} d ( x , y )}{W ( W - 1 )} ; \qquad Formula 9$$

L_{regular} represents the average path length of the initial directed network, W represents the total number of the plurality of nodes, and d(x,y) represents the shortest path length between node x and node y in the initial directed network.

In a possible implementation, the determining the average clustering coefficient of the initial directed network includes:
determining a local clustering coefficient of each node;
determining the average clustering coefficient according to the local clustering coefficient of each node and the total number of the plurality of nodes.

In an implementation, the local clustering coefficient of the initial directed network satisfies the following Formula 10:

$${C}_{r e g u l a r} = \frac{{\sum }_{i = 1}^{W} C ( i )}{W} ; \qquad Formula 10$$

C_{regular} represents the average clustering coefficient of the initial directed network, and C(i) represents a local clustering coefficient of node i.

S603, determine an optimal reconnection probability of the initial directed network according to the average path length and the average clustering coefficient of the initial directed network.

In a possible implementation, the optimal reconnection probability of the initial directed network is determined by using a genetic algorithm according to the average path length and average clustering coefficient of the initial directed network.

S604, adjust the edge between the plurality of nodes in the initial directed network according to the optimal reconnection probability to obtain the target directed network.

In a possible implementation, the adjusting the edges between the plurality of nodes in the initial directed network according to the optimal reconnection probability to obtain the target directed network includes:
generating a random number in the range of [0, 1] randomly for one edge in the initial directed network;
when the random number is less than the optimal reconnection probability, remaining the node connected to a start point of an edge unchanged, selecting a new node from the initial directed network as the node connected to an end point of the edge to establish a new edge; where the new node is a node in the initial directed network other than a node connected to the start point of the edge and an node originally connected to the end point of the edge;
when the random number is greater than or equal to the optimal reconnection probability, making no adjustment to the edge; and
repeating the above operations for all edges in the initial directed network to obtain the target directed network.

S605, determine a local clustering coefficient of a node according to a number of at least one adjacent node of the node and a number of an edge between the at least one adjacent node, where the plurality of nodes are nodes in the target directed network.

In a possible implementation, the local clustering coefficient C(i) of a node i in the plurality of nodes satisfies the following Formula 5:

$$C ( i ) = \frac{{e}_{i}}{{k}_{i} ( {k}_{i} - 1 )} ; \qquad Formula 5$$

kᵢ represents a number of adjacent nodes of node i, and eᵢ represents a number of an edge between the adjacent nodes.

The range of the local clustering coefficient is greater than or equal to 0 and less than or equal to 1; the closer the local clustering coefficient is to 1, the higher the clustering degree of the node's neighbors.

S606, determine recovery durations of the plurality of nodes and a propagation duration between each two nodes according to local clustering coefficients of the plurality of nodes.

In a possible implementation, a recovery duration Tᵣ(i) of the node i in the plurality of nodes satisfies the following Formula 6:

Tᵣ(i)=C(i)·T_{rbase} Formula 6;
C(i) represents a local clustering coefficient of the node i, and T_{rbase} represents a basic recovery duration with a value of 1 day.

In a possible implementation, the propagation duration Tₚ(i,j) between the node i and a node j in the plurality of nodes satisfies the following Formula 7:

$${T}_{p} ( i , j ) = ( 1 - \frac{C ( i ) + C ( j )}{2} ) \cdot {T}_{pbase} ; \qquad Formula 7$$

C(j) represents a local clustering coefficient of the node j, and T_{pbase} represents a basic propagation duration with a value of 1 day.

The local clustering coefficient of a node characterizes the aggregation degree of the node in the target directed network, the higher the local clustering coefficient, which means that there are a large number of adjacent nodes around this node, the more likely a failure of this node will propagate to other nodes; during the recovery of this node, according to the dynamic propagation rule, this node can only recover if all parent nodes of this node are functionally valid, the higher the local clustering coefficient, the more parent nodes (a parent node refers to a node connected to a start point of an edge directly connected to this node in the target directed network) may exist, making this node more difficult and slower to recover. In the embodiment of the present application, the recovery durations of the plurality of nodes and the propagation duration between each two nodes are determined through the local clustering coefficients of the plurality of nodes combined with the basic recovery duration and basic propagation duration, which can take into account the impact of the aggregation degree of different nodes in the target directed network on the recovery duration and propagation duration, thereby obtaining more accurate recovery duration and propagation duration.

S607, when perturbing at least one first node in the plurality of nodes, determine a failure propagation process according to the target directed network, the recovery durations of the plurality of nodes, the propagation duration between each two nodes, and an initial time instant of perturbation, where the failure propagation process includes functional states of the plurality of nodes at the initial time instant, functional states of the plurality of nodes at the end time instant, and functional states of the plurality of nodes at a plurality of candidate time instants between the initial time instant and the end time instant.

It is worth noting that an execution method of S607 is the same as that of S103 and will not be repeated here.

S608, determine a plurality of target time instants from the initial time instant, the end time instant, and the plurality of candidate time instants.

It is worth noting that an execution method of S608 is the same as that of S302 and will not be repeated here.

S609, determine instantaneous functional states of the plurality of target time instants according to the functional states of the plurality of nodes at the plurality of target time instants and device types corresponding to the plurality of nodes.

It is worth noting that an execution method of S609 is the same as that of S303 and will not be repeated here.

S610, perform curve fitting processing on the instantaneous functional states of the plurality of target time instants to obtain a security resilience variation curve.

It is worth noting that an execution method of S610 is the same as that of S402 and will not be repeated here.

S611, determine a damage degree parameter, a damage range parameter, and a capacity recovery parameter of the target directed network according to the security resilience variation curve.

It is worth noting that an execution method of S611 is the same as that of S403 and will not be repeated here.

S612, determine a perturbation risk level according to the damage degree parameter, the damage range parameter, and the capacity recovery parameter.

It is worth noting that an execution method of S612 is the same as that of S404 and will not be repeated here.

In the embodiment shown in FIG. 6, an initial directed network of the oil and gas production system is constructed according to the device information of plurality of devices in the oil and gas production system and the connection relationships between the plurality of devices; the average path length and average clustering coefficient of the initial directed network are determined; the optimal reconnection probability of the initial directed network is determined according to the average path length and average clustering coefficient; the edges between the plurality of nodes in the initial directed network are adjusted according to the optimal reconnection probability to obtain the target directed network. In the above method, the initial directed network is adjusted through the optimal reconnection probability to obtain the target directed network, which can obtain a target directed network more suitable for the oil and gas production system, thereby improving the accuracy of determining the perturbation risk level.

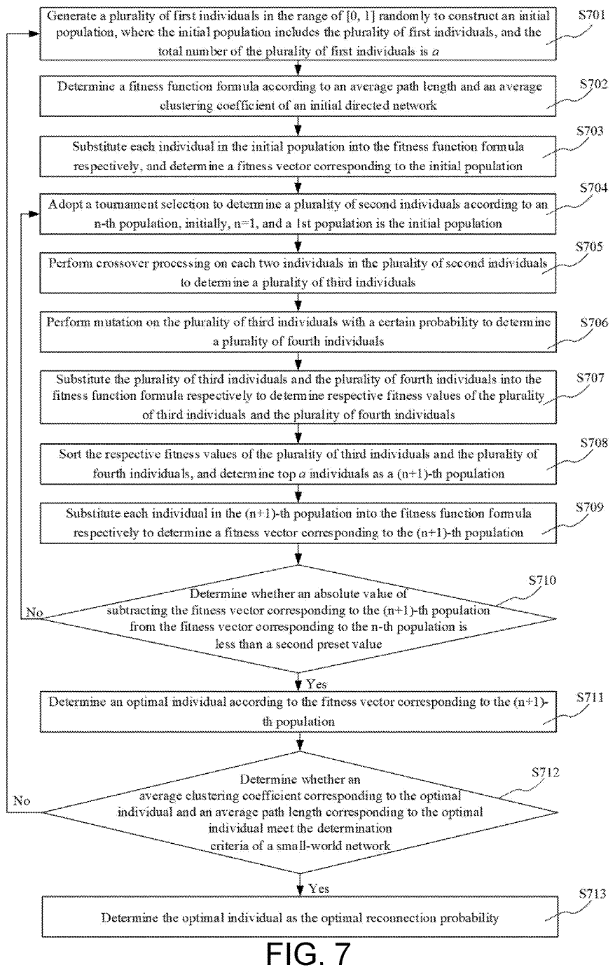

With reference to FIG. 7, the process of determining the optimal reconnection probability of the initial directed network by using genetic algorithm will be described below.

FIG. 7 is a schematic flowchart of a method for determining an optimal reconnection probability provided by an embodiment of the present application, as shown in FIG. 7, the method includes the following steps.

S701, generate a plurality of first individuals in the range of [0, 1] randomly to construct an initial population, where the initial population includes the plurality of first individuals, and the total number of the plurality of first individuals is a.

For example, a first individuals within the range of [0, 1] are randomly generated to form an initial population A={A₁, A₂, . . . , Aₐ}.

S702, determine a fitness function formula according to an average path length and an average clustering coefficient of an initial directed network.

In a possible implementation, the determining the fitness function formula according to the average path length and the average clustering coefficient of the initial directed network includes:
determining an expected average path length and an expected average clustering coefficient according to the average path length of the initial directed network and the average clustering coefficient of the initial directed network; and
determining the fitness function formula according to the expected average clustering coefficient and the expected average path length.

In an implementation, the average path length of the initial directed network and the expected average path length satisfy the following Formula 11:

L_{g}=a·log_{b}(L_{regular}·W)+c Formula 11;
L_{g} represents the expected average path length, L_{regular} represents the average path length of the initial directed network, log represents a logarithmic function, a, b and c represent parameters that take values based on experience, and W represents a total number of nodes in the initial directed network.

In an implementation, the average clustering coefficient of the initial directed network and the expected average clustering coefficient satisfy the following Formula 12:

C_{g}=C_{regular}(1−d)³ Formula 12;
C_{g} represents the expected average clustering coefficient, C_{regular} represents the average path length of the initial directed network, and d represents a randomly generated random number within the range of [0, 1].

In a possible implementation, the fitness function formula satisfies the following Formula 13:

$$F ( {A}_{{a}^{‵}} ) = {ω}_{1} \frac{{L}_{g}}{{L}_{regular} ( {A}_{{a}^{‵}} )} + {ω}_{2} \frac{{C}_{regular} ( {A}_{{a}^{‵}} )}{{C}_{g}} ; \qquad Formula 13$$

F(A_{a′}) represents the fitness value of individual A_{a′}, ω₁ and ω₂ represent weight coefficients, L_{g} represents the expected average path length, C_{g} represents the expected average clustering coefficient, L_{regular}(A_{a′}) represents the average path length corresponding to individual A_{a′}, and C_{regular}(A_{a′}) represents the average clustering coefficient corresponding to individual A_{a′}.

In an implementation, ω₁ and ω₂ take values based on experience and satisfy ω₂>ω₁.

The average path length corresponding to individual A_{a′} is: the average path length of a process directed network obtained by adjusting edges between a plurality of nodes in the initial directed network according to individual A_{a′}.

The average clustering coefficient corresponding to individual A_{a′} is: the average clustering coefficient of the process directed network obtained by adjusting edges between a plurality of nodes in the initial directed network according to individual A_{a′}.

It is worth noting that the execution method of “adjusting the edges between a plurality of nodes in the initial directed network according to individual A_{a′} to obtain the process directed network” is similar to that of S604 and will not be repeated here.

S703, substitute each individual in the initial population into the fitness function formula respectively, and determine a fitness vector corresponding to the initial population.

The fitness vector corresponding to the initial population includes the respective fitness values of each individual in the initial population.

S704, adopt a tournament selection to determine a plurality of second individuals according to an n-th population, initially, n=1, and a 1st population is the initial population.

The total number of the plurality second individuals is equal to the total number of the plurality of first individuals.

It is worth noting that the specific implementation method of S704 refers to related arts and will not be repeated here.

S705, perform crossover processing on each two individuals in the plurality of second individuals to determine a plurality of third individuals.

In a possible implementation, a relationship between two second individuals and one third individual satisfies the following Formula 14:

A_{new}=α·Aᵢ+(1−α)·Aⱼ Formula 14;
A_{new} represents a third individual, Aᵢ and Aⱼ represent the i-th second individual and the j-th second individual, a represents a crossover ratio coefficient, the crossover ratio coefficient is randomly generated and ranges in [0, 1].

S706, perform mutation on the plurality of third individuals with a certain probability to determine a plurality of fourth individuals.

In a possible implementation, a relationship between one third individual and one fourth individual satisfies the following Formula 15:

A_{mutated}=A_{new}+β·rand(−1,1) Formula 15;
A_{mutated} represents a fourth individual, β represents mutation magnitude with a value of 0.3, rand(−1,1) represents a random number greater than −1 and less than 1.

S707, substitute the plurality of third individuals and the plurality of fourth individuals into the fitness function formula respectively to determine respective fitness values of the plurality of third individuals and the plurality of fourth individuals.

S708, sort the respective fitness values of the plurality of third individuals and the plurality of fourth individuals, and determine top a individuals as a (n+1)-th population.

S709, substitute each individual in the (n+1)-th population into the fitness function formula respectively to determine a fitness vector corresponding to the (n+1)-th population.

The fitness vector corresponding to the (n+1)-th population includes the respective fitness values of each individual in the (n+1)-th population.

S710, determine whether an absolute value of subtracting the fitness vector corresponding to the (n+1)-th population from the fitness vector corresponding to the n-th population is less than a second preset value.

If yes, execute S711, otherwise, execute S704.

In a possible implementation, the subtracting the fitness vector corresponding to the (n+1)-th population from the fitness vector corresponding to the n-th population includes:
determining a first average value of the fitness vector corresponding to the (n+1)-th population;
determining a second average value of the fitness vector corresponding to the n-th population; and
determining an absolute value of subtracting the first average value and the second average value.

The second preset value is, for example, 0.1 or 0.01.

S711, determine an optimal individual according to the fitness vector corresponding to the (n+1)-th population.

In an implementation, the determining the optimal individual according to the fitness vector corresponding to the (n+1)-th population includes:
sorting all fitness values included in the fitness vector corresponding to the (n+1)-th population; and
determining an individual corresponding to the highest fitness value after sorting as the optimal individual.

S712, determine whether an average clustering coefficient corresponding to the optimal individual and an average path length corresponding to the optimal individual meet the determination criteria of a small-world network.

In a possible implementation, the determining whether the average clustering coefficient corresponding to the optimal individual and the average path length corresponding to the optimal individual meet the determination criteria of the small-world network includes:
determining whether an absolute value of the difference between the average clustering coefficient corresponding to the optimal individual and the expected average clustering coefficient is less than a third preset value, and whether an absolute value of the difference between the average path length corresponding to the optimal individual and the expected average path length is less than a fourth preset value.

In an implementation, the third preset value is, for example, 0.01, and the fourth preset value is, for example, 0.01.

If yes, execute S713, otherwise, execute S701.

S713, determine the optimal individual as the optimal reconnection probability.

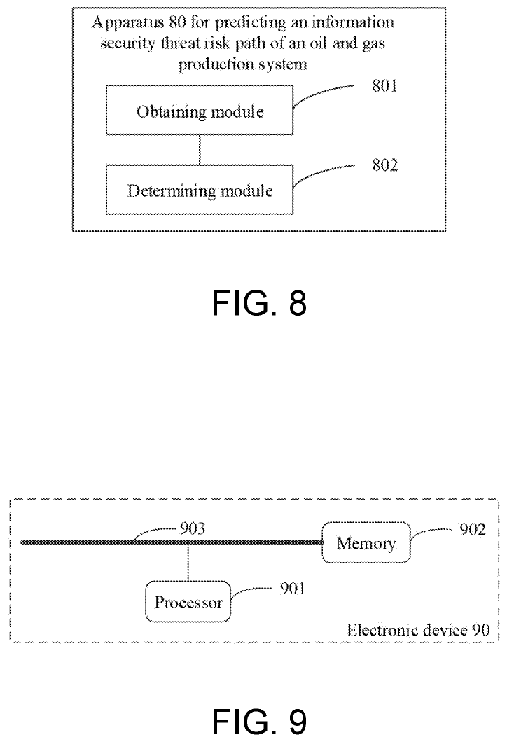

FIG. 8 is a schematic structural diagram of an apparatus for predicting an information security threat risk path of an oil and gas production system provided by an embodiment of the present application, as shown in FIG. 8, an apparatus 80 for predicting an information security threat risk path of an oil and gas production system includes:
an obtaining module 801, configured to obtain local clustering coefficients of a plurality of nodes, where the plurality of nodes are nodes in a target directed network constructed based on the oil and gas production system, and the plurality of nodes correspond to the plurality of devices;
a determining module 802, configured to determine recovery durations of the plurality of nodes and a propagation duration between each two nodes according to the local clustering coefficients of the plurality of nodes; where a recovery duration is a duration required for a node to recover from functional failure to functional validity, and the propagation duration is a duration required for function failure of a node to cause function failure of another node;
the determining module 802 is further configured to: when perturbing at least one node of the plurality of nodes, determine a failure propagation process according to the target directed network, the recovery durations of the plurality of nodes, the propagation duration between each two nodes and an initial time instant of perturbation, where the failure propagation process includes functional states of the plurality of nodes at the initial time instant, functional states of the plurality of nodes at an end time instant, and functional states of the plurality of nodes at a plurality of candidate time instants between the initial time instant and the end time instant; and the end time instant is a time instant when the target directed network returns to normal;
the determining module 802 is further configured to determine, according to the failure propagation process, a perturbation risk level of a risk path corresponding to the perturbing of the at least one node, where the perturbation risk level is used to characterize a degree of harm to the oil and gas production system caused by an attack on at least one device corresponding to the at least one node.

It should be noted here that the apparatus 80 for predicting an information security threat risk path of an oil and gas production system provided by the embodiment of the present application can implement all the method steps implemented by the above method embodiments and achieve the same technical effects, the parts and beneficial effects of the embodiment that are the same as those of the method embodiments will not be described in detail here.

In a possible implementation, the determining module 802 is specifically configured to:
determine a plurality of target time instants from the initial time instant, the end time instant and the plurality of candidate time instants;
determine instantaneous functional states of the plurality of target time instants according to functional states of the plurality of nodes at the plurality of target time instants and device types corresponding to the plurality of nodes; and
determine the perturbation risk level according to the instantaneous functional states of the plurality of target time instants.

In a possible implementation, an instantaneous functional state at a target time instant satisfies the following Formula 1:

$$r ( {t}_{k} ) = \frac{{\sum }_{n = 1}^{N} ( {α}_{n} \cdot {\sum }_{m = 1}^{{M}_{n}} ( {S}_{n m} ( {t}_{k} ) ) )}{N} ; \qquad Formula 1$$

tₖ represents the target time instant, r(tₖ) represents the instantaneous functional state corresponding to the target time instant, N represents a total number of the device types corresponding to the plurality of nodes, αₙ represents a weight corresponding to type n, Mₙ represents a total number of nodes corresponding to type n in the plurality of nodes, Sₙₘ(tₖ) represents a functional state of node m in the node corresponding to type n at the target time instant.

In a possible implementation, the determining module 802 is specifically configured to:
perform curve fitting processing on the instantaneous functional states of the plurality of target time instants to obtain a security resilience variation curve;
determine a damage degree parameter, a damage range parameter, and a capacity recovery parameter of the target directed network according to the security resilience variation curve; and
determine the perturbation risk level according to the damage degree parameter, the damage range parameter and the capacity recovery parameter.

In one possible implementation, the damage degree parameter S₁ satisfies the following Formula 2:

$${S}_{1} = A - {\int }_{{t}_{s t a r t}}^{{t}_{e n d}} R ( t ) dt ; \qquad Formula 2$$

A represents a preset value associated with the end time instant and the initial time instant, t_{end} represents the end time instant, tₛₜₐᵣₜ represents the initial time instant, R(t) represents the security resilience variation curve, ∫ represents an integral sign, and dt represents a differential sign;
the damage range parameter S₂ satisfies the following Formula 3:

S₂=1/Rₘᵢₙ Formula 3;
Rₘᵢₙ represents a minimum value of R(t), and/represents a division operation;
the capacity recovery parameter S₃ satisfies the following Formula 4:

$$\{ \begin{matrix}{S}_{3} = \frac{1}{P} {\sum }_{p = 1}^{P} \vert {K}_{p} \vert \\ {S}_{3} = 0\end{matrix} ; \qquad Formula 4$$

P represents a number of at least one sub-curve, the at least one sub-curve is a curve obtained by dividing a first curve according to at least two first time instants, the at least two first time instants include a target time instant corresponding to Rₘᵢₙ, t_{end}, and a target time instant between the target time instant corresponding to Rₘᵢₙ and t_{end}, the first curve is a curve between the target time instant corresponding to Rₘᵢₙ and the end time instant in R(t), Kₚ represents a slope corresponding to curve p in the at least one sub-curve.

In a possible implementation, the determining module 802 is specifically configured to:
determine a product of the damage degree parameter and the damage range parameter; and
determine a ratio of the product to the capacity recovery parameter as the perturbation risk level.

In a possible implementation, the obtaining module 801 is specifically configured to:
determine the local clustering coefficient of the node according to a number of at least one adjacent node of the node and a number of an edge between the at least one adjacent node.

In a possible implementation, a local clustering coefficient C(i) of a node i in the plurality of nodes satisfies the following Formula 5:

$$C ( i ) = \frac{{e}_{i}}{{k}_{i} ( {k}_{i} - 1 )} ; \qquad Formula 5$$

kᵢ represents a number of adjacent nodes of the node i, and eᵢ represents a number of an edge between the adjacent nodes.

In a possible implementation, a recovery duration Tᵣ(i) of a node i in the plurality of nodes satisfies the following Formula 6:

Tᵣ(i)=C(i)·T_{rbase} Formula 6;
C(i) represents a local clustering coefficient of the node i, and T_{rbase} represents a basic recovery duration;
a propagation duration Tₚ(i,j) between the node i and a node j in the plurality of nodes satisfies the following Formula 7:

$${T}_{p} ( i , j ) = ( 1 - \frac{C ( i ) + C ( j )}{2} ) \cdot {T}_{p b a s e} ; \qquad Formula 7$$

C(j) represents a local clustering coefficient of the node j, and T_{pbase} represents a basic propagation duration.

In a possible implementation, the determining module 802 is further configured to:
construct an initial directed network of the oil and gas production system according to device information of the plurality of devices in the oil and gas production system and a connection relationship between the plurality of devices, where the initial directed network includes the plurality of nodes and an edge between the plurality of nodes, and the edge indicates that there is a connection between devices corresponding to nodes on the edge, and a direction of the edge indicates an information transmission direction or an oil and gas transmission direction between the devices corresponding to the nodes on the edge;
determine an average path length and an average clustering coefficient of the initial directed network;
determine an optimal reconnection probability of the initial directed network according to the average path length and the average clustering coefficient; and
adjust the edge between the plurality of nodes in the initial directed network according to the optimal reconnection probability to obtain the target directed network.

It should be noted here that an apparatus 80 for predicting an information security threat risk path of an oil and gas production system provided by the embodiment of the present application can implement all the method steps implemented by the above method embodiments and achieve the same technical effects, the parts and beneficial effects of the embodiment that are the same as those of the method embodiments will not be described in detail here.

It should be understood that the above-mentioned apparatus 80 for predicting an information security threat risk path of an oil and gas production system is embodied in the form of functional modules. The term “module” herein may refer to an application-specific integrated circuit (ASIC), an electronic circuit, a processor (such as a shared processor, a proprietary processor or a group processor, etc.) and a memory for executing at least one software or firmware program, a merged logic circuit and/or other suitable components supporting the described functions.

FIG. 9 is a structural diagram of an electronic device provided by an embodiment of the present application, as shown in FIG. 9, the electronic device 90 includes a processor 901 and a memory 902. Where the processor 901 is connected with the memory 902 in communication, and the memory 902 is configured to store instructions executed by the computer; the processor 901 is configured to execute the technical solution in any of the aforementioned method embodiments by executing computer-executed instructions stored in the memory 902.

In an implementation, the memory 902 can be independent or integrated with the processor 901. In an implementation, when the memory 902 is a device independent of the processor 901, the electronic device 900 may further include a bus 903 for connecting the above components.

The electronic device is configured to execute the technical solutions in any of the aforementioned method embodiments, and its implementation principles and technical effects are similar, which will not be repeated herein.

In the above embodiments, it should be understood that the processor can be a central processing unit (CPU), but may also be other general-purpose processors, digital signal processors (DSP), application specific integrated circuits (ASIC) and so on. The general-purpose processor may be a microprocessor or the processor may be any conventional processor. The steps of the method disclosed in combination with the invention can be directly embodied in the hardware processor to perform the completion, or with the processor in the hardware and software module combination to perform the completion.

The memory may include random access memory (RAM) or may also include non-volatile memory (NVM), such as at least one disk memory.

The bus can be an industry standard architecture (ISA) bus, a peripheral component (PCI) bus or an extended industry standard architecture (EISA) bus, and so on. The bus can be divided into address bus, data bus and control bus. For convenience of representation, the bus in the drawings of the present application is not limited to only one bus or type of bus.

The application further provides a computer program product, including a computer program, which implements the above method when executed by a processor.

The application further provides a computer-readable storage medium, in which computer-executable instructions are stored; when the processor executes the computer-executable instructions, the above method is implemented.

The computer readable storage media and the readable storage media described above may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or CD-ROM. A readable storage medium may be any available medium that can be accessed by a general-purpose or specialized computer.

An exemplary readable storage medium is coupled to the processor such that the processor is capable of reading information from the readable storage medium and may write information to the readable storage medium. Of course, the readable storage medium may also be an integral part of the processor. The processor and the readable storage medium may be located in application specific integrated circuits (ASIC). Of course, the processor and the readable storage medium may also be present in the device as discrete components.

The division of the units as described is only a logical functional division, and the actual implementation can be divided in another way, for example, multiple units or components can be combined or can be integrated into another system, or some features can be ignored, or not implemented. As another point, the coupling or direct coupling or communication connection between each other shown or discussed may be indirect coupling or communication connection through some interface, device or unit, which may be electrical, mechanical or other forms.

The units described as separate components may or may not be physically separated, and the components displayed as units may or may not be physical units, that is, they may be located in one place or distributed to multiple network units. Some or all of the units can be selected according to actual needs to achieve the purpose of this embodiment.

In addition, each functional unit in each embodiment of the present invention can be integrated into one processing unit, or each unit can exist physically alone, or two or more units can be integrated into one unit.

The functions described above can be stored in a computer-readable storage medium if they are implemented in the form of software functional units and sold or used as independent products. Based on this understanding, the technical solution of the present invention can be embodied in the form of a software product, which is stored in a storage medium and includes several instructions to make a computer device (which can be a personal computer, a server, a network device, etc.) execute all or part of the steps of the method described in various embodiments of the present invention. The aforementioned storage media include: U disk, mobile hard disk, Read-Only Memory (ROM), Random Access Memory (RAM), magnetic disk or optical disk and other media that can store program codes.

A person of ordinary skill in the art can understand that implementing all or part of the processes in the methods of the aforementioned embodiments may be accomplished by instructing related hardware by means of a computer program, the computer program may be stored in a non-volatile computer readable storage medium, and when being executed, the computer program may include the processes of the aforementioned method embodiments; The aforementioned storage media include ROM, RAM, magnetic disk or optical disk and other media that can store program codes.

Finally, it should be noted that: after considering the specification and practicing the invention disclosed herein, those skilled in the art will easily conceive of other implementations of the present invention. The present invention is intended to cover any modifications, uses, or adaptive changes of the present invention, which comply with the general principles of the present invention and include common general knowledge or conventional technical means in the technical field not disclosed by the present invention. It is not limited to the precise structure described above and shown in the drawings, and various modifications and changes may be made without departing from its scope. The scope of the present invention is only limited by the appended claims.

What is claimed is:

1. A method for predicting an information security threat risk path of an oil and gas production system, wherein the oil and gas production system comprises a plurality of devices, comprising:
obtaining local clustering coefficients of a plurality of nodes, wherein the plurality of nodes are nodes in a target directed network constructed based on the oil and gas production system, and the plurality of nodes correspond to the plurality of devices;
determining recovery durations of the plurality of nodes and a propagation duration between each two nodes according to the local clustering coefficients of the plurality of nodes; wherein a recovery duration is a duration required for a node to recover from functional failure to functional validity, and the propagation duration is a duration required for function failure of a node to cause function failure of another node;
when perturbing at least one first node of the plurality of nodes, determining a failure propagation process according to the target directed network, the recovery durations of the plurality of nodes, the propagation duration between each two nodes and an initial time instant of perturbation, wherein the failure propagation process comprises functional states of the plurality of nodes at the initial time instant, functional states of the plurality of nodes at an end time instant, and functional states of the plurality of nodes at a plurality of candidate time instants between the initial time instant and the end time instant; and the end time instant is a time instant when the target directed network returns to normal; and
determining, according to the failure propagation process, a perturbation risk level of a risk path corresponding to the perturbing of the at least one first node, wherein the perturbation risk level is used to characterize a degree of harm to the oil and gas production system caused by an attack on at least one device corresponding to the at least one first node.

2. The method according to claim 1, wherein the determining, according to the failure propagation process, the perturbation risk level of the risk path corresponding to the perturbing of the at least one first node comprises:
determining a plurality of target time instants from the initial time instant, the end time instant and the plurality of candidate time instants;
determining instantaneous functional states of the plurality of target time instants according to functional states of the plurality of nodes at the plurality of target time instants and device types corresponding to the plurality of nodes; and
determining the perturbation risk level according to the instantaneous functional states of the plurality of target time instants.

3. The method according to claim 2, wherein an instantaneous functional state at a target time instant satisfies the following Formula 1:
$$r ( {t}_{k} ) = \frac{{\sum }_{n = 1}^{N} ( {α}_{n} \cdot {\sum }_{m = 1}^{{M}_{n}} ( {S}_{n m} ( {t}_{k} ) ) )}{N} ; \qquad Formula 1$$
wherein tₖ represents the target time instant, r(tₖ) represents the instantaneous functional state corresponding to the target time instant, N represents a total number of the device types corresponding to the plurality of nodes, αₙ represents a weight corresponding to type n, Mₙ represents a total number of nodes corresponding to type n in the plurality of nodes, Sₙₘ(tₖ) represents a functional state of node m in the node corresponding to type n at the target time instant.

4. The method according to claim 3, wherein the determining the perturbation risk level according to the instantaneous functional states of the plurality of target time instants comprises:
performing curve fitting processing on the instantaneous functional states of the plurality of target time instants to obtain a security resilience variation curve;
determining a damage degree parameter, a damage range parameter, and a capacity recovery parameter of the target directed network according to the security resilience variation curve; and
determining the perturbation risk level according to the damage degree parameter, the damage range parameter and the capacity recovery parameter.

5. The method according to claim 4, wherein the damage degree parameter S₁ satisfies the following Formula 2:
$${S}_{1} = A - {\int }_{{t}_{s t a r t}}^{{t}_{e n d}} R ( t ) dt ; \qquad Formula 2$$
wherein A represents a preset value associated with the end time instant and the initial time instant, t_{end} represents the end time instant, tₛₜₐᵣₜ represents the initial time instant, R(t) represents the security resilience variation curve, ∫ represents an integral sign, and dt represents a differential sign;
the damage range parameter S₂ satisfies the following Formula 3:
S₂=1/Rₘᵢₙ Formula 3;
wherein Rₘᵢₙ represents a minimum value of R(t), and/represents a division operation;
the capacity recovery parameter S₃ satisfies the following Formula 4:
$$\{ \begin{matrix}{S}_{3} = \frac{1}{P} {\sum }_{p = 1}^{P} \vert {K}_{p} \vert \\ {S}_{3} = 0\end{matrix} ; \qquad Formula 4$$
wherein P represents a number of at least one sub-curve, the at least one sub-curve is a curve obtained by dividing a first curve according to at least two first time instants, the at least two first time instants comprise a target time instant corresponding to Rₘᵢₙ, t_{end}, and a target time instant between the target time instant corresponding to Rₘᵢₙ and t_{end}, the first curve is a curve between the target time instant corresponding to Rₘᵢₙ and the end time instant in R(t), Kₚ represents a slope corresponding to curve p in the at least one sub-curve.

6. The method according to claim 4, wherein the determining the perturbation risk level according to the damage degree parameter, the damage range parameter, and the capacity recovery parameter comprises:
determining a product of the damage degree parameter and the damage range parameter; and
determining a ratio of the product to the capacity recovery parameter as the perturbation risk level.

7. The method according to claim 1, wherein obtaining a local clustering coefficient of a node in the target directed network comprises:
determining the local clustering coefficient of the node according to a number of at least one adjacent node of the node and a number of an edge between the at least one adjacent node; and
a local clustering coefficient C(i) of a node i in the plurality of nodes satisfies the following Formula 5:
$$C ( i ) = \frac{{e}_{i}}{{k}_{i} ( {k}_{i} - 1 )} ; \qquad Formula 5$$
wherein kᵢ represents a number of adjacent nodes of the node i, and eᵢ represents a number of an edge between the adjacent nodes.

8. The method according to claim 1, wherein a recovery duration Tᵣ(i) of a node i in the plurality of nodes satisfies the following Formula 6:
Tᵣ(i)=C(i)·T_{rbase} Formula 6;
wherein C(i) represents a local clustering coefficient of the node i, and T_{rbase} represents a basic recovery duration;
a propagation duration Tₚ(i,j) between the node i and a node j in the plurality of nodes satisfies the following Formula 7:
$${T}_{p} ( i , j ) = ( 1 - \frac{C ( i ) + C ( j )}{2} ) \cdot {T}_{p b a s e} ; \qquad Formula 7$$
wherein C(j) represents a local clustering coefficient of the node j, and T_{pbase} represents a basic propagation duration.

9. The method according to claim 1, wherein the method further comprises:
constructing an initial directed network of the oil and gas production system according to device information of the plurality of devices in the oil and gas production system and a connection relationship between the plurality of devices, wherein the initial directed network comprises the plurality of nodes and an edge between the plurality of nodes, and the edge indicates that there is a connection between devices corresponding to nodes on the edge, and a direction of the edge indicates an information transmission direction or an oil and gas transmission direction between the devices corresponding to the nodes on the edge;
determining an average path length and an average clustering coefficient of the initial directed network;
determining an optimal reconnection probability of the initial directed network according to the average path length and the average clustering coefficient; and
adjusting the edge between the plurality of nodes in the initial directed network according to the optimal reconnection probability to obtain the target directed network.

10. An apparatus for predicting an information security threat risk path of an oil and gas production system, wherein the oil and gas production system comprises a plurality of devices, comprising:
at least one processor; and
a memory communicatively connected to the at least one processor; wherein
the memory stores an instruction executable by the at least one processor, and the instruction is executed by the at least one processor to enable the at least one processor to:
obtain local clustering coefficients of a plurality of nodes, wherein the plurality of nodes are nodes in a target directed network constructed based on the oil and gas production system, and the plurality of nodes correspond to the plurality of devices;
determine recovery durations of the plurality of nodes and a propagation duration between each two nodes according to the local clustering coefficients of the plurality of nodes; wherein a recovery duration is a duration required for a node to recover from functional failure to functional validity, and the propagation duration is a duration required for function failure of a node to cause function failure of another node;
when perturbing at least one first node of the plurality of nodes, determine a failure propagation process according to the target directed network, the recovery durations of the plurality of nodes, the propagation duration between each two nodes and an initial time instant of perturbation, wherein the failure propagation process comprises functional states of the plurality of nodes at the initial time instant, functional states of the plurality of nodes at an end time instant, and functional states of the plurality of nodes at a plurality of candidate time instants between the initial time instant and the end time instant; and the end time instant is a time instant when the target directed network returns to normal; and
determine, according to the failure propagation process, a perturbation risk level of a risk path corresponding to the perturbing of the at least one first node, wherein the perturbation risk level is used to characterize a degree of harm to the oil and gas production system caused by an attack on at least one device corresponding to the at least one first node.

11. The apparatus according to claim 10, wherein the at least one processor is further enabled to:
determine a plurality of target time instants from the initial time instant, the end time instant and the plurality of candidate time instants;
determine instantaneous functional states of the plurality of target time instants according to functional states of the plurality of nodes at the plurality of target time instants and device types corresponding to the plurality of nodes; and
determine the perturbation risk level according to the instantaneous functional states of the plurality of target time instants.

12. The apparatus according to claim 11, wherein an instantaneous functional state at a target time instant satisfies the following Formula 1:
$$r ( {t}_{k} ) = \frac{{\sum }_{n = 1}^{N} ( {α}_{n} \cdot {\sum }_{m = 1}^{{M}_{n}} ( {S}_{n m} ( {t}_{k} ) ) )}{N} ; \qquad Formula 1$$
wherein tₖ represents the target time instant, r(tₖ) represents the instantaneous functional state corresponding to the target time instant, N represents a total number of the device types corresponding to the plurality of nodes, αₙ represents a weight corresponding to type n, Mₙ represents a total number of nodes corresponding to type n in the plurality of nodes, Sₙₘ(tₖ) represents a functional state of node m in the node corresponding to type n at the target time instant.

13. The apparatus according to claim 12, wherein the at least one processor is further enabled to:
perform curve fitting processing on the instantaneous functional states of the plurality of target time instants to obtain a security resilience variation curve;
determine a damage degree parameter, a damage range parameter, and a capacity recovery parameter of the target directed network according to the security resilience variation curve; and
determine the perturbation risk level according to the damage degree parameter, the damage range parameter and the capacity recovery parameter.

14. The apparatus according to claim 13, wherein the damage degree parameter S₁ satisfies the following Formula 2:
$${S}_{1} = A - {\int }_{{t}_{s t a r t}}^{{t}_{e n d}} R ( t ) dt ; \qquad Formula 2$$
wherein A represents a preset value associated with the end time instant and the initial time instant, t_{end} represents the end time instant, tₛₜₐᵣₜ represents the initial time instant, R(t) represents the security resilience variation curve, ∫ represents an integral sign, and dt represents a differential sign;
the damage range parameter S₂ satisfies the following Formula 3:
S₂=1/Rₘᵢₙ Formula 3;
wherein Rₘᵢₙ represents a minimum value of R(t), and/represents a division operation;
the capacity recovery parameter S₃ satisfies the following Formula 4:
$$\{ \begin{matrix}{S}_{3} = \frac{1}{P} {\sum }_{p = 1}^{P} \vert {K}_{p} \vert \\ {S}_{3} = 0\end{matrix} ; \qquad Formula 4$$
wherein P represents a number of at least one sub-curve, the at least one sub-curve is a curve obtained by dividing a first curve according to at least two first time instants, the at least two first time instants comprise a target time instant corresponding to Rₘᵢₙ, t_{end}, and a target time instant between the target time instant corresponding to Rₘᵢₙ and t_{end}, the first curve is a curve between the target time instant corresponding to Rₘᵢₙ and the end time instant in R(t), Kₚ represents a slope corresponding to curve p in the at least one sub-curve.

15. The apparatus according to claim 13, wherein the at least one processor is further enabled to:
determine a product of the damage degree parameter and the damage range parameter; and
determine a ratio of the product to the capacity recovery parameter as the perturbation risk level.

16. The apparatus according to claim 10, wherein the at least one processor is further enabled to:
determine the local clustering coefficient of the node according to a number of at least one adjacent node of the node and a number of an edge between the at least one adjacent node; and
a local clustering coefficient C(i) of a node i in the plurality of nodes satisfies the following Formula 5:
$$C ( i ) = \frac{{e}_{i}}{{k}_{i} ( {k}_{i} - 1 )} ; \qquad Formula 5$$
wherein kᵢ represents a number of adjacent nodes of the node i, and eᵢ represents a number of an edge between the adjacent nodes.

17. The apparatus according to claim 10, wherein a recovery duration Tᵣ(i) of a node i in the plurality of nodes satisfies the following Formula 6:
Tᵣ(i)=C(i)·T_{rbase} Formula 6;
wherein C(i) represents a local clustering coefficient of the node i, and T_{rbase} represents a basic recovery duration;
a propagation duration Tₚ(i,j) between the node i and a node j in the plurality of nodes satisfies the following Formula 7:
$${T}_{p} ( i , j ) = ( 1 - \frac{C ( i ) + C ( j )}{2} ) \cdot {T}_{p b a s e} ; \qquad Formula 7$$
wherein C(j) represents a local clustering coefficient of the node j, and T_{pbase} represents a basic propagation duration.

18. The apparatus according to claim 10, wherein the at least one processor is further enabled to:
construct an initial directed network of the oil and gas production system according to device information of the plurality of devices in the oil and gas production system and a connection relationship between the plurality of devices, wherein the initial directed network comprises the plurality of nodes and an edge between the plurality of nodes, and the edge indicates that there is a connection between devices corresponding to nodes on the edge, and a direction of the edge indicates an information transmission direction or an oil and gas transmission direction between the devices corresponding to the nodes on the edge;
determine an average path length and an average clustering coefficient of the initial directed network;
determine an optimal reconnection probability of the initial directed network according to the average path length and the average clustering coefficient; and
adjust the edge between the plurality of nodes in the initial directed network according to the optimal reconnection probability to obtain the target directed network.

19. A non-transitory computer-readable storage medium storing computer instructions, wherein the computer instructions are used to enable a computer to:
obtain local clustering coefficients of a plurality of nodes, wherein the plurality of nodes are nodes in a target directed network constructed based on the oil and gas production system, and the plurality of nodes correspond to the plurality of devices;
determine recovery durations of the plurality of nodes and a propagation duration between each two nodes according to the local clustering coefficients of the plurality of nodes; wherein a recovery duration is a duration required for a node to recover from functional failure to functional validity, and the propagation duration is a duration required for function failure of a node to cause function failure of another node;
when perturbing at least one first node of the plurality of nodes, determine a failure propagation process according to the target directed network, the recovery durations of the plurality of nodes, the propagation duration between each two nodes and an initial time instant of perturbation, wherein the failure propagation process comprises functional states of the plurality of nodes at the initial time instant, functional states of the plurality of nodes at an end time instant, and functional states of the plurality of nodes at a plurality of candidate time instants between the initial time instant and the end time instant; and the end time instant is a time instant when the target directed network returns to normal; and
determine, according to the failure propagation process, a perturbation risk level of a risk path corresponding to the perturbing of the at least one first node, wherein the perturbation risk level is used to characterize a degree of harm to the oil and gas production system caused by an attack on at least one device corresponding to the at least one first node.

20. The non-transitory computer-readable storage medium according to claim 19, wherein the computer is further enable to:
determine a plurality of target time instants from the initial time instant, the end time instant and the plurality of candidate time instants;
determine instantaneous functional states of the plurality of target time instants according to functional states of the plurality of nodes at the plurality of target time instants and device types corresponding to the plurality of nodes; and
determine the perturbation risk level according to the instantaneous functional states of the plurality of target time instants.
